(19) United States
(12) Patent Application Publication
(10) Pub. No.: US 2015/0349923 A1
(43) Pub. Date: Dec. 3, 2015

(54) Sphere Decoding Detection Method And Device

(71) Applicant: ZTE CORPORATION, Shenzhen, Guangdong (CN)

(72) Inventor: Pengpeng QIAO, Shenzhen City, Guangdong Province (CN)

(21) Appl. No.: 14/654,601

(22) PCT Filed: Jul. 23, 2013
(86) PCT No.: PCT/CN2013/079929

§ 371 Date: Jun. 22, 2015

(30) Foreign Application Priority Data
Dec. 24, 2012 (CN) 201210566917.9

(51) Int. Cl. H04L 1/00; H04B 7/04; H04B 7/08

(52) U.S. Cl. CPC H04L 1/0052; H04B 7/0854; H04L 1/0047; H04B 7/0413

(57) ABSTRACT

Disclosed are a sphere decoding detection method and apparatus, including: preprocessing a received signal to obtain a signal approximate estimation value Xₚᵣₑ of the received signal, deducing an initial square radius D² of sphere decoding detection according to Xₚᵣₑ, and determining the size I of a constellation space according to the current signal to noise ratio of the received signal; according to depth first and sphere constraint rules, searching for a search path depending on the size I of the constellation space and an initial square radius D²; after a search path is searched out, and when the sum of local Euclidean distances of the searched-out search path is less than the current square radius, updating the square radius, and re-searching for a search path until a search path cannot be searched out, and determining a candidate signal point corresponding to the latest saved search path as the optimum signal estimation point.

### CROSS-REFERENCE TO RELATED APPLICATION(S)

This application is the U.S. National Phase application of PCT application number PCT/CN2013/079929 having a PCT filing date of Jul. 23, 2013, which claims priority of Chinese patent application 201210566917.9 filed on Dec. 24, 2012, the disclosures of which are hereby incorporated by reference.

### TECHNICAL FIELD

The present invention relates to the field of mobile communications, and more particularly, to a sphere decoding detection method and apparatus.

### BACKGROUND OF THE RELATED ART

In recent years, a large number of researchers have been carrying out extensive and in-depth research on the signal detection methods in the wireless MIMO communication system. The signal detection methods comprise: Maximum Likelihood Detection (MLD), Zero Forcing (ZF), Minimum Mean Square Error (MMSE) detection, Semi-Definite Relaxation (SDR) and Sphere Decoding (SD) detection and so on.

The MLD has the best performance, but its complexity reaches the exponent level and is almost impossible to be implemented in hardware. Although the calculation of the ZF and MMSE detections is simple, their BER performance is quite poor, and because the semi-definite relaxation detection performs relaxation processing on conditions on the basis of the MLD, there is a lot of performance loss. The SD detection has a bit error performance approaching to the MLD and its complexity is moderate, thus it is a relatively ideal signal detection method.

The complexity of a standard sphere decoding detection method is still high, the implementation of its hardware design is relatively difficult; in order to make the SD detection better implemented in hardware, some improved versions of the SD detection have been proposed. Fincke-Pohst SD (FP-SD) is an effective strategy, and the algorithm searches for the optimal signal point by enumerating all the constellation grid points within a hyper-sphere with a given initial radius. Since the algorithm only narrows the search space once, the selection of its initial radius D is relatively sensitive. Aiming at this defect, some people calls the Schnorr-Euchner algorithm which is applied to the SD as SE-SD, and the depth-first search order is used to search, which achieves good results in terms of reducing the complexity.

The published specification of Chinese Patent Application CN200910084580.6 disclosed a sphere decoding detection method based on depth-first search, although it has a good control on the algorithm complexity, there is some signal performance loss due to the limitation that the maximum number of nodes in the tree search is M.

The published specification of Chinese Patent Application CN201010515931.7 disclosed a depth-first SD detection algorithm based on the QR preprocessing, and the method is only suitable for signal detection in the high SNR region and the MIMO with the low-order modulation, but it is not suitable for signal detection in the low SNR region.

### SUMMARY OF THE INVENTION

The embodiment of the present invention provides a sphere decoding detection method and apparatus to lower computational complexity on the basis of not reducing the bit error performance.

To solve the abovementioned technical problem, a sphere decoding detection method according to an embodiment of the present invention comprises:

performing pre-processing on a received signal to obtain a signal approximate estimation value Xₚᵣₑ of the received signal, deducing an initial square radius D² of sphere decoding detection according to the Xₚᵣₑ, determining the size I of a constellation space according to a current signal to noise ratio of the received signal;

according to depth first and sphere constraint rules, searching for a search path according to the size I of the constellation space and the initial square radius D², wherein all nodes through which the search path passes fall within a sphere which takes the initial square radius as a radius;

after searching out a search path, and the sum of local Euclidean distances of the searched-out search path is less than a current square radius, updating the square radius, and within a multidimensional sphere which takes the received signal as a center of the sphere and the updated square radius as a radius, re-searching for a search path until no search path can be searched out, and determining a candidate signal point corresponding to the latest saved search path as an optimal signal estimation point.

Alternatively, the step of performing pre-processing on the received signal to obtain a signal approximate estimation value Xₚᵣₑ of the received signal comprises:

performing processing on the received signal via a semi-definite relaxation detector to obtain the approximate estimation value Xₚᵣₑ of the received signal.

Alternatively, the step of deducing the initial square radius D² of the sphere decoding detection according to the Xₚᵣₑ, comprises:

D²=∥Y′−Ŷ∥, wherein Y′=Q^{T}Y, Ŷ=R\hat{X}ₚᵣₑ, and Y is the received signal, \hat{X}ₚᵣₑ is a hard decision of Xₚᵣₑ, Q is a unitary matrix, and R is an upper triangular matrix.

Alternatively, the step of determining the size I of the constellation space according to the current signal to noise ratio of the received signal comprises:

determining that the value of the size I of the constellation space increases with the current signal to noise ratio of the received signal increasing.

Alternatively, the step of searching for a search path depending on the size I of the constellation space and the initial square radius D² according to the depth-first and the sphere constraint rules comprises:

generating I child nodes of a current node and calculating a node list, and according to a descending order of priorities of nodes in the node list, calculating the sum d(x_{(k,t)}) of local Euclidean distances of nodes in a k-th layer;

judging whether the sum d(x_{(k,t)}) of Local Euclidean distances of a node is greater than Dₖ^{′2} or not, if the d(x_{(k,t)}) of the node is greater than Dₖ^{′2}, then cutting off the node, returning to a (k+1)-th layer, and re-expanding searched child nodes; if the d(x_{(k,t)}) of the node is not greater than Dₖ^{′2}, when k is not equal to 1, entering into the (k−1)-th layer to search, when k=1, searching out a search path, wherein Dₖ^{′2} is a component of a vector.

Alternatively, calculating the node list comprises:

searching for constellation nodes falling in a multi-dimensional sphere which takes the received signal as the center and D² as the square radius, sorting the constellation nodes in the multidimensional sphere according to an ascending order of the local Euclidean distances to obtain a node list corresponding to the constellation nodes in the multi-dimensional sphere.

Alternatively, a sphere decoding detection apparatus, comprising: a pre-processing unit, a square radius calculating unit, a constellation space size determining unit and a path searching unit, wherein:

the pre-processing unit is configured to perform pre-processing on a received signal to obtain a signal approximate estimation value Xₚᵣₑ of the received signal;

the square radius calculating unit is configured to deduce an initial square radius D² of sphere decoding detection according to the Xₚᵣₑ;

the constellation space size determining unit is configured to determine the size I of a constellation space according to a current signal to noise ratio of the received signal;

the path searching unit is configured to, according to depth-first and sphere constraint rules, search for a search path depending on the size I of the constellation space and the initial square radius D², wherein all the nodes through which the search path passes fall into a sphere which takes the initial square radius as a radius, and after searching out a search path and the sum of local Euclidean distances of the searched-out search path is less than the current square radius, update the square radius, and re-search for a search path within a multidimensional sphere which takes the received signal as a center of the sphere and the updated hyper-sphere square radius as a radius until no search path can be searched out, and determine a candidate signal point corresponding to the latest saved search path as an optimal signal estimation point.

Alternatively, the pre-processing unit performing preprocessing on the received signal to obtain a signal approximate estimation value Xₚᵣₑ of the received signal refers to performing processing on the received signal via a semi-definite relaxation detector to obtain the approximate estimation value Xₚᵣₑ of the received signal.

Alternatively, the constellation space size determining unit determining the size I of the constellation space according to the current signal to noise ratio of the received signal refers to, determining that the value of the size I of the constellation space increases with the current signal to noise ratio of the received signal increasing.

Alternatively, the square radius calculating unit deducing the initial sphere radius D² of the square decoding detection according to the Xₚᵣₑ refers to calculating D²=∥Y′−Ŷ∥, wherein Y′=Q^{T}Y, Ŷ=R\hat{X}ₚᵣₑ, Y is the received signal, \hat{X}ₚᵣₑ is a hard decision of Xₚᵣₑ, Q is a unitary matrix, and R is an upper triangular matrix;

the path searching unit searching for a search path depending on the size I of the constellation space and the initial square radius D² according to the depth-first and sphere constraint rules refers to generating I child nodes of a current node and calculating a node list, calculating the sum d(x_{(k,t)}) of local Euclidean distances of nodes in a k-th layer according to the descending order of priorities of nodes in the node list, judging whether the sum d(x_{(k,t)}) of local Euclidean distances of a node is greater than Dₖ^{′2} or not, if the d(x_{(k,t)}) of the node is greater than Dₖ^{′2}, then cutting off the node, and returning to a (k+1)-th layer, re-expanding searched child nodes; if the d(x_{(k,t)}) of the node is not greater than Dₖ^{′2}, when k is not equal to 1, entering into the (k−1)-th layer to search, when k=1, searching out a search path, wherein D₂^{′2} is a component of a vector.

In summary, the embodiment of the present invention has the following advantageous effects:

the embodiment of the present invention is a SNR adaptive MIMO signal detection method based on the sphere decoding detection, and it performs preprocessing with a semi-definite relaxation detector to deduce a relatively tight initial square radius and a traversal order of the tree search, and the relative small initial square radius may reduce the number of nodes accessed in the tree search, and using the nearest constellation grid points from the pre-detected signal to start searching shortens the time for searching out the optimal signal grid point in the tree search;

more importantly, adjusting the number of searched constellation grid points according to different SNR effectively reduces the number of nodes accessed in the tree search while keeping the signal quality (bit error performance) unchanged, therefore the embodiment of the present invention has the advantages of reducing system operation time, improving the real-time processing capability of the system, reducing power consumption of the terminal device, and extending the standby time of the terminal.

### BRIEF DESCRIPTION OF THE DRAWINGS

FIG. 1 is a system model in accordance with an embodiment of the present invention;

FIG. 2 is a flow chart of a sphere decoding detection method in accordance with an embodiment of the present invention;

FIG. 3 is a flow chart of searching for a search path in an implementation of an embodiment of the present invention;

FIG. 4 is a schematic diagram of a method for selecting the size of a constellation space under different signal to noise ratio in an implementation method in accordance with the present application;

FIG. 5 is a diagram of analyzing the bit error performance of the implementation method in accordance with an embodiment of the present invention;

FIG. 6 is a diagram of analyzing the complexity of the implementation method with a simulation in accordance with an embodiment of the present invention;

FIG. 7 is a structural diagram of a sphere decoding detection apparatus in accordance with an embodiment of the present invention.

### PREFERRED EMBODIMENTS OF THE INVENTION

Hereinafter, in conjunction with the accompanying drawings, the embodiments of the present invention will be described in detail. It should be noted that, in the case of no conflict, embodiments and features in the embodiments of the present application may be combined arbitrarily with each other.

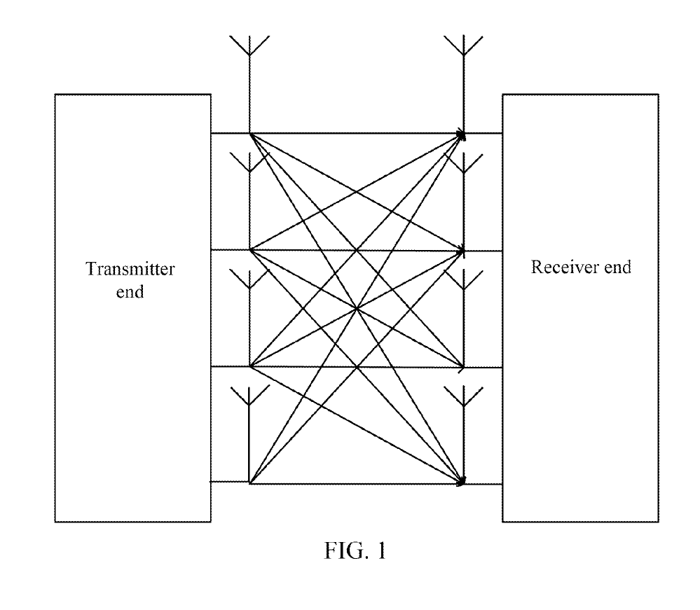

As shown in FIG. 1, a MIMO wireless communication system with 4 transmitters and 4 receivers is taken as an example in the following to illustrate the principle of this method, the channel model of the MIMO wireless communication system with 4 transmitters and 4 receivers is: \tilde{Y}=\acute{H}\acute{X}+\acute{X}, wherein Y is a 4×1 received signal complex column vector, X is a 4×1 transmitted signal complex column vector, His a 4×4 independent and identically distributed Rayleigh fading channel transmission matrix, elements of the H are \tilde{h}ᵢⱼ˜CN(0,1) (i=0, 1, 2, 3, 4; j=1, 2, 3, 4), wherein CN(0,1) is a complex Gaussian distribution with mean of 0 and variance of 1, \tilde{W} is a 4×1 ideal additive complex Gaussian white noise column vector, \tilde{w}ᵢ˜CN(0,σ²) (i=1, 2, 3, 4).

In order to facilitate the numerical calculation, the abovementioned complex channel model is converted into a real channel model:

$$\begin{matrix}Y = [ \begin{matrix}Re ( \tilde{Y} ) \\ Im ( \tilde{Y} )\end{matrix} ] \\ = HX + W\end{matrix} = [ \begin{matrix}Re ( \tilde{H} ) & Im ( \tilde{H} ) \\ Im ( \tilde{H} ) & - Re ( \tilde{H} )\end{matrix} ] \times [ \begin{matrix}Re ( \tilde{X} ) \\ Im ( \tilde{X} )\end{matrix} ] + [ \begin{matrix}Re ( \tilde{W} ) \\ Im ( \tilde{W} )\end{matrix} ]$$

For the tree search process of the sphere decoding detection, the model can be represented as: D²≧∥Y−HX∥²;

For ease of calculation, QR decomposition is performed on the channel matrix H, that is, H=QR, wherein Q is a unitary matrix, and R is an upper triangular matrix, then the above equation is equivalent to:

D^{′2}≧∥Y−RX∥², wherein Y′=Q^{T}Y, and ∥•∥² represents the norm of the matrix, and D^{′2}≧∥Y−RX∥² is represented in the form of matrix:

$$( \begin{matrix}{D}_{1}^{′ 2} \\ {D}_{2}^{′ 2} \\ ⋮ \\ {D}_{8}^{′ 2}\end{matrix} ) \geq {‖ ( \begin{matrix}{y}_{1}^{′} \\ {y}_{2}^{′} \\ ⋮ \\ {y}_{8}^{′}\end{matrix} ) - ( \begin{matrix}{r}_{1 , 1} & {r}_{1 , 2} & … & {r}_{1 , 8} \\ & {r}_{2 , 2} & … & {r}_{2 , 8} \\ & & ⋱ & ⋮ \\ & & & {r}_{8 , 8}\end{matrix} ) ( \begin{matrix}{x}_{1} \\ {x}_{2} \\ ⋮ \\ {x}_{8}\end{matrix} ) ‖}^{2}$$

As can be seen from the abovementioned model that the essence of SD detection is a tree search process, namely the implementation of searching for constellation grid points on a tree, to search out one shortest search path, wherein a vector composed of the corresponding values is the desired signal estimation value.

Hereinafter, in conjunction with the accompanying drawings, the embodiments of the present invention will be described in detail.

The complexity of existing detection methods is relatively high, especially in the low SNR region, the complexity of SD detection algorithm is quite high, and its hardware design implementation is relatively difficult; or even if it can be designed in hardware, its cost is large, and its real-time performance is poor or the power consumption is big, and it is far away from being commercialized in a large range.

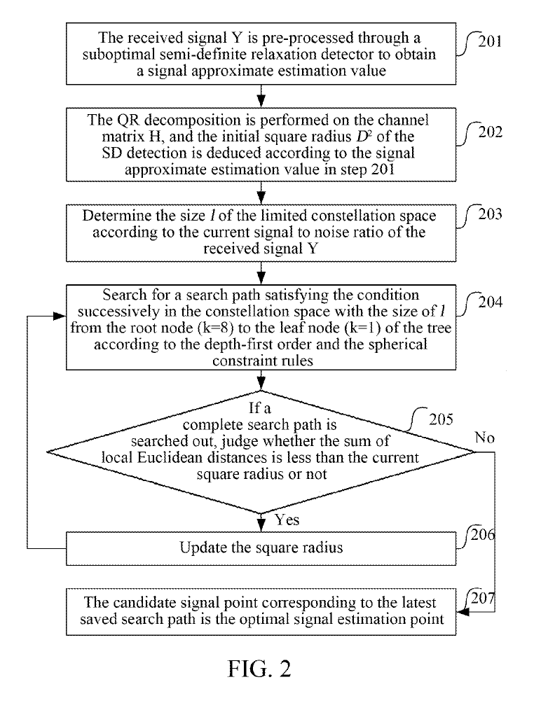

As shown in FIG. 2, the sphere decoding detection method in the present embodiment comprises:

in step 201: the terminal device pre-processes the received signal Y through one suboptimal semi-definite relaxation detector to obtain a signal approximate estimation value Xₚᵣₑ;

The method for achieving the semi-definite relaxation detector is as follows:

the essence of semi-definite relaxation detection is relaxing the constraint conditions accordingly on the basis of the MLD, and converting it into a semi-positive definite planning problem which can be solved in polynomial time, and it is a convex optimization problem on its nature.

The MLD can be described as:

$${\hat{x}}_{ML} = {arg min}_{X ∈ Z} {‖ Y - HX ‖}^{2} ;$$

according to the definition of the 2-norm,

∥Y−HX∥²=(Y−HX)^{T}(Y−HX)=Trace(Qww^{T})

wherein

$$Q = [ \begin{matrix}{H}^{T} H & - {H}^{T} Y \\ - {Y}^{T} H & {Y}^{T} Y\end{matrix} ] , w = [ \begin{matrix}X \\ 1\end{matrix} ] ,$$

Trace(•) represents the trace of matrix. So the MLD can be converted into:

$$min Trace ( QW ) s . t . \{ \begin{matrix}diag ( W ) = E , & ( a ) \\ W = {ww}^{T} , & ( b )\end{matrix} \qquad$$

wherein

$$W = {ww}^{T} = [ \begin{matrix}{XX}^{T} & X \\ {X}^{T} & 1\end{matrix} ] ,$$

E represents a column vector in which all elements are 1. The relaxation processing is performed on equation (b) in the above equation, so that the problem of MLD detection can be transformed into a convex optimization problem, namely:

$$min Trace ( QW )$$

$$s . t . \{ \begin{matrix}diag ( W ) = E \\ W ≻ = 0\end{matrix}$$

where W>=0 represents one symmetric and positive definite matrix.

Since the MLD is finally converted into a convex optimization problem through semi-definite relaxation, the problem can be solved with the interior point method, which has the polynomial complexity.

The advantages of selecting the semi-definite relaxation detector to perform pre-detection are:

performing pre-detection can ensure that searching for the optimal signal point within the multidimensional sphere provided with the initial square radius thereafter will not fail.

The semi-definite relaxation pre-detection has better bit error performance than the conventional ZF detection and MMSE detection, especially in the low SNR region, the semi-definite relaxation pre-detection has better bit error performance than the ZF and MMSE pre-detections, so that a smaller radius can be deduced, and unwanted signal points can be eliminated in advance, and the desired optimal signal point can be searched out quickly.

The computational complexity of semi-definite relaxation detection is constant, regardless of low SNR or high SNR, and regardless of using the low-order modulation or the high-order modulation. However, the complexity of the ZF and MMSE is relatively low in the low order modulation and the high signal to noise ratio, if experiencing a high-order modulation or low SNR environment, the complexity will increase rapidly.

In step 202: the terminal device performs QR decomposition on the channel matrix H (in order to facilitate the calculation), and deduces the initial square radius D² of the SD detection according to the signal approximate estimation value Xₚᵣₑ in step 201;

the method for solving D² is: D²=∥Y′−Ŷ∥

wherein Y′=Q^{T}Y, Ŷ=R\hat{X}ₚᵣₑ, and \hat{X}ₚᵣₑ is the hard decision of Xₚᵣₑ.

In step 203: the terminal device determines the size I of the limited constellation space according to the current signal to noise ratio of the received signal Y;

the distribution of the I constellation grid points is shown in FIG. 4. The possible values of I are: 9, 13, 21, 37, 55, 64.

The value of I in different SNR in the present embodiment is corresponded in accordance with the following table:

| SNR(dB): | 0 | 5 | 10 | 15 | 20 | 25 | 30 |
|---|---|---|---|---|---|---|---|
| The number of limited constellations I: | 9 | 13 | 21 | 37 | 55 | 64 | 64 |

The advantage of limiting the size of the searched constellation grid points at different SNR lies in that the bit error performance of existing sphere detection methods has small difference with other suboptimal detections under low SNR, in other words, in the low signal to noise ratio regions, there are few really useful signal points, then it may consider to limit the size of the constellation space, adjusting (reduce) the size of the constellation space depending on the difference of signal to noise ratio, which can greatly reduce the computational complexity in the corresponding SNR range under the condition of keeping the BER performance constant

In step 204: the terminal device searches for a search path satisfying the condition in the constellation space with the size of I from the root node (k=8) to the leaf node (k=1) of the tree according to the depth-first order and the sphere constraint rules;

the depth-first refers to entering into the next layer to search rather than continuing to search for all the nodes meeting the conditions in this layer after searching out one node meeting the conditions in each layer of the tree in the process of executing the tree search.

The spherical constraint is to cut off nodes of the tree that fall outside the sphere.

A search path meeting the condition refers to a search path departing from the root node to the leaf node of the tree, and all the nodes through which the path passes must fall within the sphere.

The order of searching for the nodes in each layer of the tree is: searching according to the order of the node list.

The calculation method of node list is: first searching for constellation nodes falling within the multidimensional sphere which takes the received signal as the center of the sphere and D² as the square radius, then sorting in accordance with the ascending order of the local Euclidean distances to obtain a node list with constellation nodes to be preferably searched.

The method for calculating the Euclidean distance of the t-th node in the k-th layer as well as the sum of local Euclidean distances is:

$$d ( {x}_{( k , t )} ) = {\sum }_{i = k}^{8} δ ( {x}_{( k , t )} ) = {\sum }_{i = k}^{8} ( \vert {y}_{k}^{′} - {\sum }_{t = k}^{8} {r}_{i , t} {x}_{t} ) ,$$

wherein

$$δ ( {x}_{( k )} ) = {\vert {y}_{k}^{′} - {\sum }_{t = k}^{8} {r}_{k , t} {x}_{t} \vert}^{2} .$$

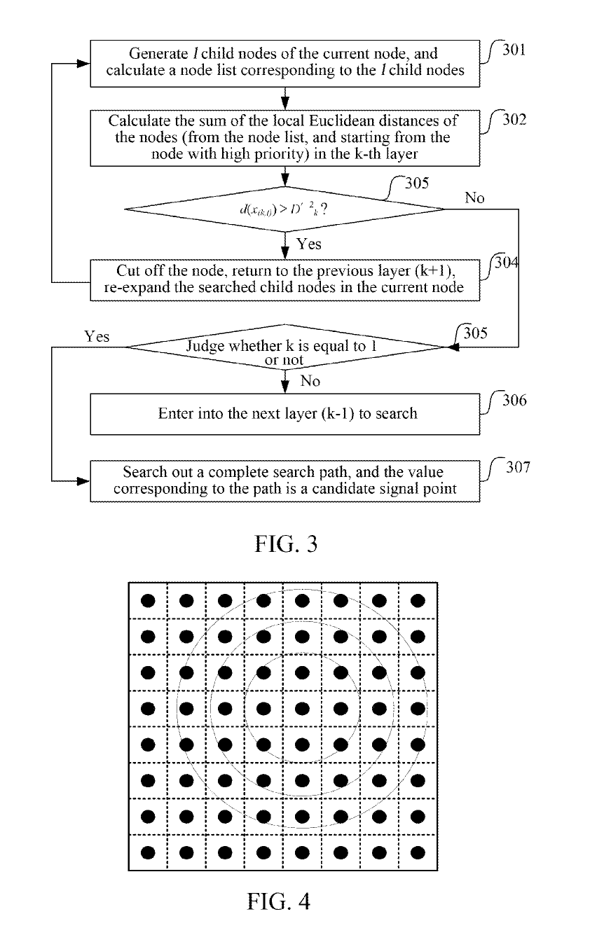

As shown in FIG. 3, the method for determining the optimal path according to the node list comprises:

in step 301: the terminal device generates I child nodes of the current node, and calculates a node list corresponding to the I child nodes;

in step 302: the terminal device calculates the sum d(x_{(k,t)}) of the local Euclidean distances of the nodes (selected from the node list, and starting from the node with high priority) in the k-th layer;

in step 303: the terminal device judges whether d(x_{(k,t)})>Dₖ^{′2} or not, if d(x_{(k,t)})>Dₖ^{′2}, proceeding to step 304; if d(x_{(k,t)}) is not greater than Dₖ^{′2}, proceeding to step 305;

Dₖ^{′2} is one component of a vector.

In step 304: the terminal device cuts off the node, returns to the previous layer (k+1), re-expands the searched child nodes in the current node, proceeding to step 301;

in step 305: the terminal device judges whether k is equal to 1 or not, and if k is not equal to 1, proceeding to step 306; if k=1, proceeding to step 307;

in step 306: it is to enter into the next layer (k−1) to search;

in step 307: the terminal device follows the abovementioned steps until k=1, that is, the tree search reaches a leaf node, at this time, a complete search path is searched out, and the value corresponding to the path is a candidate signal point X=(x₁, x₂, . . . , x₈).

In step 205: if searching out a complete search path, the terminal device judges whether the sum of local Euclidean distances is less than the current square radius or not, and if the sum of local Euclidean distances is less than the current square radius, proceeding to step 206; if the sum of local Euclidean distances is no less than the current square radius, proceeding to step 207;

in step 206: the terminal device updates the square radius, and takes the sum of local Euclidean distances of the search path as the updated square radius, and in a multidimensional sphere which takes the received signal as the center of the sphere and the updated square radius as the radius, it continues to search for the optimal tree search path according to method of step 204, until a complete search path cannot be searched out after the radius is updated at the latest, that is, a leaf nodes of the tree cannot be searched out, proceeding to step 207;

in step 207: the terminal device takes a candidate signal point corresponding to the latest saved search path as the optimal signal estimation point, and this search ends.

In the following, a simulation is used to test the effects of SD detection in the present embodiment.

Simulation Environment: single user, a MIMO communication system with 4 transmitters and 4 receivers, the channel estimation is an ideal channel estimation, and the channel state information is known at the receiver end, the transmitter end does not perform channel encoding on the signal, the 64QAM modulation is used, and the channel is a non-correlated flat Rayleigh fading channel.

Simulation content and simulation results:

the SD-PRO signal detection method in the present embodiment and the existing SD detection as well as the traditional detection perform bit error performance analysis and average complexity analysis.

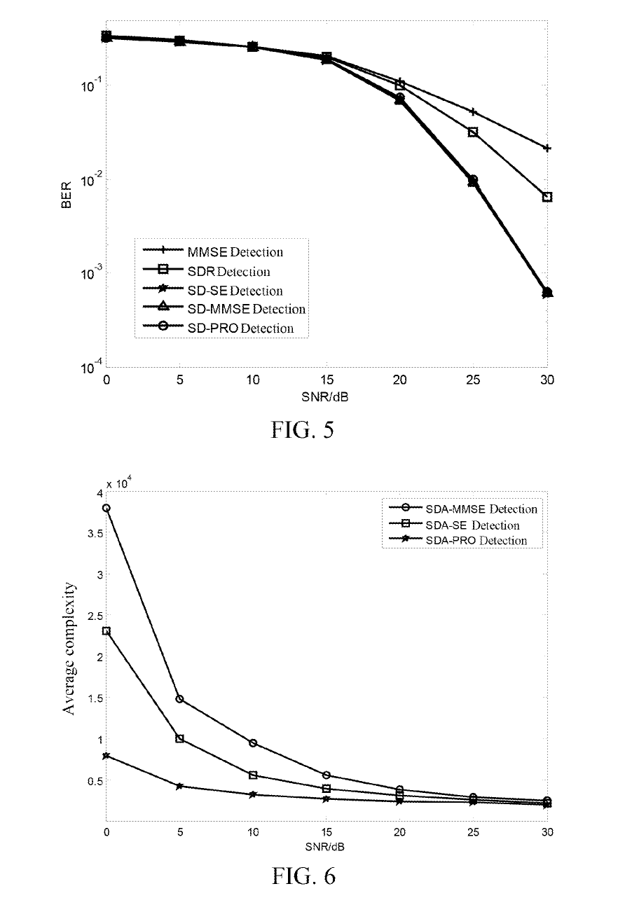

As can be seen from FIG. 5, the present embodiment basically maintains the bit error performance of the existing SD detection, that is, the performance loss is very small, and almost negligible.

As can be seen from the FIG. 6, the SD detection method in the present embodiment has a smaller computational complexity, and especially in the low SNR region, the amplitude of the reduction of calculation complexity is relatively large.

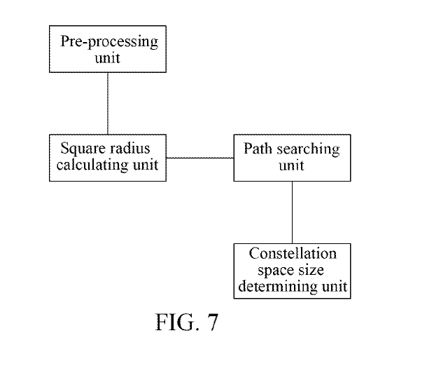

As shown in FIG. 7, the present embodiment further provides a sphere decoding detection apparatus, comprising: a pre-processing unit, a square radius calculating unit, a constellation space size determining unit and a path searching unit, wherein:

the pre-processing unit is configured to pre-process a received signal to obtain a signal approximate estimation value Xₚᵣₑ of the received signal;

the square radius calculating unit is configured to deduce the initial square radius D² of sphere decoding detection according to the Xₚᵣₑ;

the constellation space size determining unit is configured to determine the size I of the constellation space according to the current signal to noise ratio of the received signal;

the path searching unit is configured to, according to the depth-first and sphere constraint rules, search for a search path depending on the size I of the constellation space and the initial square radius D², all the nodes through which the search path passes fall into the sphere which takes the initial square radius as the radius, and after searching out a search path and the sum of local Euclidean distances of the searched-out search path is less than the current square radius, update the square radius, and re-search for a search path within a multidimensional sphere which takes the received signal as the center of the sphere and the updated hyper-sphere square radius as the radius, until no search path can be searched out, determine a candidate signal point corresponding to the latest saved search path as the optimum signal estimation point.

The pre-processing unit preprocessing the received signal to obtain an approximate estimation value Xₚᵣₑ of the received signal refers to processing the received signal via a semi-definite relaxation detector to obtain the approximate estimation value Xₚᵣₑ of the received signal.

The constellation space size determining unit determining the size I of the constellation space in accordance with the current signal to noise ratio of the received signal refers to, determining that the value of the size I of the constellation space increases with the current signal to noise ratio of the received signal increasing.

The square radius calculating unit deducing the initial sphere radius D² of the square decoding detection according to the Xₚᵣₑ refers to calculating D²=∥Y′−Ŷ∥, wherein Y′=Q^{T}Y, Ŷ=R\hat{X}ₚᵣₑ, Y is the received signal, \hat{X}ₚᵣₑ is a hard decision of Xₚᵣₑ, Q is a unitary matrix, and R is an upper triangular matrix;

the path searching unit searching for a search path depending on the size I of the constellation space and the initial square radius D² according to the depth-first and sphere constraint rules refers to generating I child nodes of the current node and calculating a node list, and according to the descending order of priorities of the nodes in the node list, calculating the sum d(x_{(k,t)}) of local Euclidean distances of the nodes in the k-th layer, judging whether the sum d(x_{(k,t)}) of local Euclidean distances of nodes is greater than Dₖ^{′2} or not, if the d(x_{(k,t)}) of the nodes is greater than Dₖ^{′2}, then cutting off the nodes, and returning to the (k+1)-th layer, re-expanding the searched child nodes; if the d(x_{(k,t)}) of the nodes is not greater than Dₖ^{′2}, when k is not equal to 1, entering into the (k−1)-th layer to search, when k=1, searching out a search path, wherein Dₖ^{′2} is one component of a vector.

Those ordinarily skilled in the art can understand that all or some of steps of the abovementioned method may be completed by the programs instructing the relevant hardware, and the abovementioned programs may be stored in a computer-readable storage medium, such as read only memory, magnetic or optical disk. Alternatively, all or some of the steps of the abovementioned embodiments may also be implemented by using one or more integrated circuits. Accordingly, each module/unit in the abovementioned embodiments may be realized in a form of hardware, or in a form of software function modules. The present invention is not limited to any specific form of hardware and software combinations.

The above embodiments are merely provided for describing rather than limiting the technical solutions of the present application, and only merely describe the present application in detail with reference to the preferred embodiments. A person of ordinary skill in the art will understand that the technical solution of the present application can be modified or replaced equivalently, and without departing from the spirit and scope of technical solution of the present application, all these modifications and equivalent replacements shall be covered by the scope of the claims of the present application.

### INDUSTRIAL APPLICABILITY

The embodiment of the present invention is a SNR adaptive MIMO signal detection method based on the sphere decoding detection, and it performs preprocessing with a semi-definite relaxation detector to deduce a relatively tight initial square radius and a traversal order of the tree search, and the relative small initial square radius may reduce the number of nodes accessed in the tree search, and using the nearest constellation grid points from the pre-detected signal to start searching shortens the time for searching out the optimal signal grid point in the tree search; more importantly, adjusting the number of searched constellation grid points according to different SNR effectively reduces the number of nodes accessed in the tree search while keeping the signal quality (bit error performance) unchanged, therefore the embodiment of the present invention has the advantages of reducing system operation time, improving the real-time processing capability of the system, reducing power consumption of the terminal device, and extending the standby time of the terminal.

What is claimed is:

1. A sphere decoding detection method, comprising:
performing pre-processing on a received signal to obtain a signal approximate estimation value Xₚᵣₑ of the received signal, deducing an initial square radius D² of sphere decoding detection according to the Xₚᵣₑ, determining the size I of a constellation space according to a current signal to noise ratio of the received signal;
according to depth-first and sphere constraint rules, searching for a search path according to the size I of the constellation space and the initial square radius D², wherein all nodes through which the search path passes fall within a sphere which takes the initial square radius as a radius;
after searching out a search path, and the sum of local Euclidean distances of the searched-out search path is less than a current square radius, updating the square radius, and within a multidimensional sphere which takes the received signal as a center of the sphere and the updated square radius as a radius, re-searching for a search path until no search path can be searched out, and determining a candidate signal point corresponding to the latest saved search path as an optimal signal estimation point.

2. The method of claim 1, wherein the step of performing pre-processing on a received signal to obtain a signal approximate estimation value Xₚᵣₑ of the received signal comprises:
performing processing on the received signal via a semi-definite relaxation detector to obtain the approximate estimation value Xₚᵣₑ of the received signal.

3. The method of claim 1, wherein the step of deducing an initial square radius D² of sphere decoding detection according to the Xₚᵣₑ comprises:
the D²=∥Y′−Ŷ∥, wherein Y′=Q^{T}Y, Ŷ=R\hat{X}ₚᵣₑ, and Y is the received signal, \hat{X}ₚᵣₑ is a hard decision of Xₚᵣₑ, Q is a unitary matrix, and R is an upper triangular matrix.

4. The method of claim 1, wherein the step of determining the size I of a constellation space according to a current signal to noise ratio of the received signal comprises:
determining that the value of the size I of the constellation space increases with the current signal to noise ratio of the received signal increasing.

5. The method of claim 1, wherein the step of searching for a search path depending on the size I of the constellation space and the initial square radius D² according to depth-first and sphere constraint rules comprises:
generating I child nodes of a current node and calculating a node list, and according to a descending order of priorities of nodes in the node list, calculating the sum d(x_{(k,t)}) of local Euclidean distances of nodes in a k-th layer;
judging whether the sum d(x_{(k,t)}) of local Euclidean distances of nodes is greater than Dₖ^{′2} or not, if the d(x_{(k,t)}) of the nodes is greater than Dₖ^{′2}, then cutting off the nodes, returning to a (k+1)-th layer, and re-expanding searched child nodes; if the d(x_{(k,t)}) of the nodes is not greater than Dₖ^{′2}, when k is not equal to 1, entering into a (k−1)-th layer to search, when k=1, searching out one search path, wherein Dₖ^{′2} is one component of a vector.

6. The method of claim 5, wherein calculating the node list comprises:
searching for constellation nodes falling in a multi-dimensional sphere which takes the received signal as a center and D² as the square radius, sorting the constellation nodes in the multidimensional sphere according to an ascending order of the local Euclidean distances to obtain a node list corresponding to the constellation nodes in the multi-dimensional sphere.

7. A sphere decoding detection apparatus, comprising: a pre-processing unit, a square radius calculating unit, a constellation space size determining unit and a path searching unit, wherein:
the pre-processing unit is configured to pre-process a received signal to obtain a signal approximate estimation value Xₚᵣₑ of the received signal;
the square radius calculating unit is configured to deduce an initial square radius D² of sphere decoding detection according to the Xₚᵣₑ;
the constellation space size determining unit is configured to determine the size I of a constellation space according to a current signal to noise ratio of the received signal;
the path searching unit is configured to, according to depth-first and sphere constraint rules, search for a search path depending on the size I of the constellation space and the initial square radius D², wherein all nodes through which the search path passes fall into a sphere which takes the initial square radius as a radius, and after searching out a search path and the sum of local Euclidean distances of the searched-out search path is less than a current square radius, update the square radius, and re-search for a search path within a multidimensional sphere which takes the received signal as a center of the sphere and updated hyper-sphere square radius as a radius until no search path can be searched out, determine a candidate signal point corresponding to the latest saved search path as an optimal signal estimation point.

8. The apparatus of claim 7, wherein:
the pre-processing unit preprocessing the received signal to obtain a signal approximate estimation value Xₚᵣₑ of the received signal refers to processing the received signal via a semi-definite relaxation detector to obtain the approximate estimation value Xₚᵣₑ of the received signal.

9. The apparatus of claim 7, wherein:
the constellation space size determining unit determining the size I of the constellation space according to the current signal to noise ratio of the received signal refers to, determining that the value of the size I of the constellation space increases with the current signal to noise ratio of the received signal increasing.

10. The apparatus of claim 7, wherein:
the square radius calculating unit deducing the initial sphere radius D² of the square decoding detection according to the Xₚᵣₑ refers to calculating the D²=∥Y′−Ŷ∥, wherein Y′=Q^{T}Y, Ŷ=R\hat{X}ₚᵣₑ, Y is the received signal, \hat{X}ₚᵣₑ is a hard decision of Xₚᵣₑ, Q is a unitary matrix, and R is an upper triangular matrix;
the path searching unit searching for a search path depending on the size I of the constellation space and the initial square radius D² according to the depth-first and sphere constraint rules refers to generating I child nodes of a current node and calculating a node list, calculating the sum d(x_{(k,t)}) of local Euclidean distances of nodes in a k-th layer according to a descending order of priorities of nodes in the node list, judging whether the sum d(x_{(k,t)}) of local Euclidean distances of nodes is greater than Dₖ^{′2} or not, if the d(x_{(k,t)}) of the nodes is greater than Dₖ^{′2}, then cutting off the nodes, and returning to a (k+1)-th layer, re-expanding searched child nodes; if the d(x_{(k,t)}) of the nodes is not greater than Dₖ^{′2}, when k is not equal to 1, entering into a (k−1)-th layer to search, when k=1, searching out one search path, wherein Dₖ^{′2} is one component of a vector.
